(19) United States
(12) Patent Application Publication
(10) Pub. No.: US 2026/0151695 A1
(43) Pub. Date: Jun. 4, 2026

(54) DETECTABLE CONTROLLER FACEPLATE TO ADJUST CONTROLLER SETTINGS

(71) Applicant: ACCO BRANDS CORPORATION, Lake Zurich, IL (US)

(72) Inventor: Yannik WIGGEMANS, Lake Zurich, IL (US)

(73) Assignee: ACCO BRANDS CORPORATION, Lake Zurich, IL (US)

(21) Appl. No.: 18/963,937

(22) Filed: Nov. 29, 2024

(51) Int. Cl. A63F 13/24; A63F 13/22; A63F 13/28

(52) U.S. Cl. CPC A63F 13/24; A63F 13/22; A63F 13/28

(57) ABSTRACT

A faceplate for a video game controller can be swapped out with a different faceplate to change controller settings such as, for example, LED settings. The faceplates may contain hidden artwork through etched away areas that can be revealed through light emitting diodes light illuminating therethrough. Controller settings may also include sensitivity of analog sticks, different inputs mapped to programmable buttons, etc.

### FIELD OF INVENTION

The present invention relates to video games, in particular to handheld controllers for playing video games.

### BACKGROUND

Third-party game controller manufacturers have continuously added new features to existing controllers to make their products stand out. Features like turbo buttons, paddle buttons, customizable controls, RGB lighting, and others have been included to enhance a user’s experience. Existing methods can be tedious to set up and make transferring settings between controllers difficult.

### SUMMARY OF THE INVENTION

As such, there currently exists a need to more easily adjust controller settings between controllers. The present disclosure relates to a detectable controller faceplate. Detecting the specific faceplate being installed on the controller can be used to adjust controller settings. In accordance with an embodiment, the faceplate includes a body and a communication device that interfaces with a video game controller. The communication device may include data to be received by the video game controller. The video game controller may use the data to identify the faceplate and change or more settings based on the detected faceplate.

In one embodiment, the communication device uses near field communication (NFC).

In one embodiment, the video game controller may control one or more light emitting diodes (LEDs) on the controller body to illuminate based on the faceplate that is detected installed on the video game controller.

In one embodiment, the faceplate further includes artwork on the faceplate, wherein one or more areas of the artwork are translucent to allow light to shine through.

In one embodiment, the settings may correspond to programmable buttons, sensitivity of controller inputs, or specific functions assigned to controller inputs.

### BRIEF DESCRIPTION OF THE DRAWINGS

FIGS. 1A and !B illustrate front and back of an example controller body.

FIGS. 2A and 2B illustrate a front and back view of a swappable faceplate.

FIGS. 3A and 3B illustrate front views of a faceplate with example hidden artwork being illuminated by light emitting diodes (LEDs).

FIG. 4 illustrates a block diagram of an example game controller.

FIG. 5 a flow diagram for an example method for adjusting controller settings of a controller by detecting a faceplate.

### DETAILED DESCRIPTION

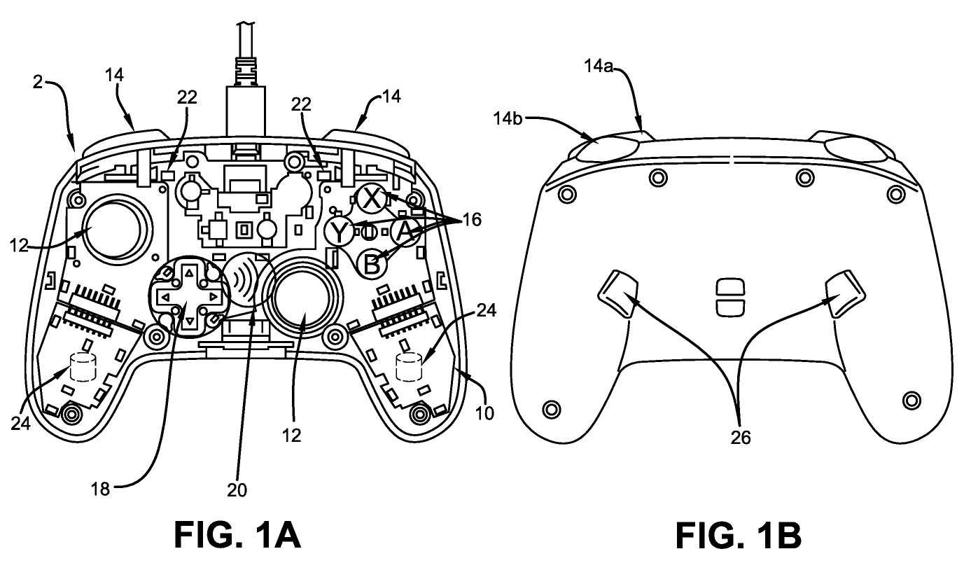

FIGS. 1A and 1B illustrate an example game controller 2 with its faceplate removed. The video game controller 2 includes a controller body 10. Operatively installed to the controller body 10 may be at least one analog stick 12, at least two trigger buttons 14 (which may include shoulder trigger inputs 14a and lower trigger inputs 14b), at least one action button 16, and at least one directional pad 18. The analog stick 12, trigger buttons 14, action button 16, and directional pad 18 of the video game controller 2 may serve as a first control interface between the controller’s user and a desired video game. In the embodiments depicted in the example game controller 2 in FIGS. 1A-3B, the control interface of the video game controller 2 includes two analog sticks 12, two trigger buttons 14, a plurality of action buttons 16, and one directional pad 18.

In some embodiments, the video game controller 2 may include light emitting diodes (LEDs) 22. In some embodiments, the video game controller 2 may include a plurality of rumble motors 24. In some embodiments, the video game controller 2 may include additional programmable buttons 26 that can be programmed to mimic inputs from buttons such as the action buttons 16 or trigger buttons 14.

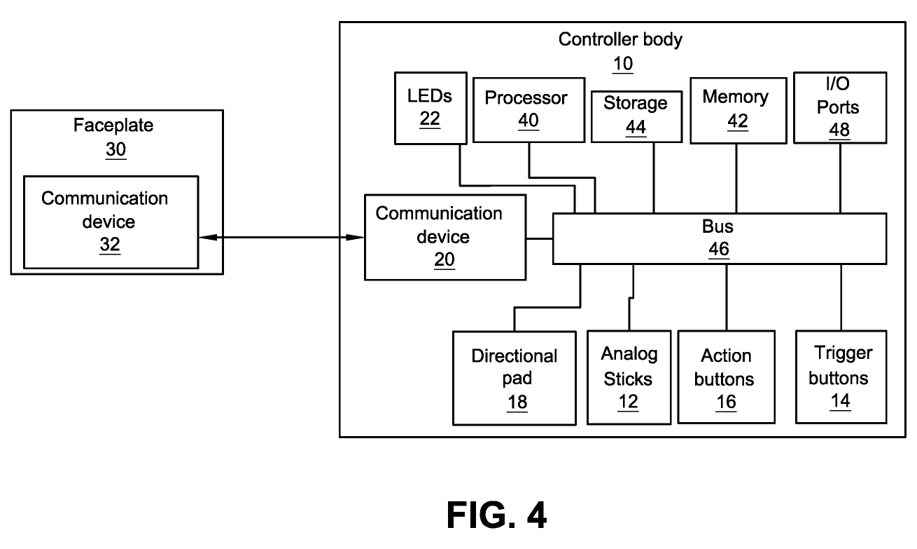

The video game controller 2 may also include a communication device 20 operatively connected to the controller body 10. The communication device 20 may be located in one of the few available portions of the body where it does not interfere with any other electronics, while also making sure to not block any light from the LEDs 22. The communication device 20 may be operatively connected to a processor 40 (shown in FIG. 4). The processor 40 can adjust controller settings. Some of these controller settings may include, but are not limited to, analog stick sensitivity, instructions on which LEDs 22 to illuminate, or assigning inputs to one or more programmable buttons on the controller.

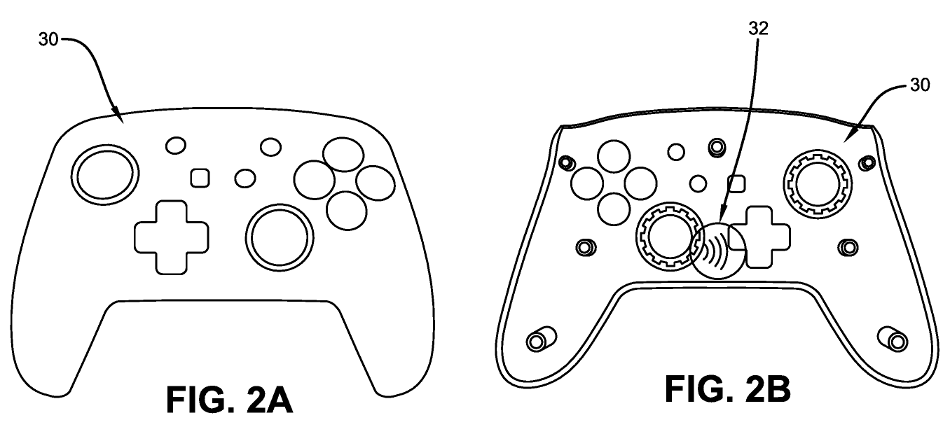

FIGS. 2A and 2B illustrate front and back views of a swappable faceplate 30. The faceplate 30 may be removably attached to the video game controller body 10 (FIG. 1). The faceplate 30 can be removed and swapped out for a similar faceplate 30. Each faceplate 30 can contain data stored in a faceplate communication device 32. When the faceplate 30 is placed onto the video game controller body 10, the controller communication device 20 (FIG. 1A) may communicate with the faceplate communication device 32. The faceplate communication device 32 may send data (e.g., faceplate identifying data, controller settings data, etc.) over to the controller communication device 20 (FIG. 1). The faceplate communication device 32 may be a passive-type communication device that generally receives any power from the controller communication device 32. In one example, the faceplate communication device 32 and the controller communication device 20 communicate through near-field communication (NFC). Some other non-limiting examples of communication may also include radio frequency identification (RFID), Bluetooth low energy (BLE), and magnetic secure transmission (MST).

The ability for the faceplate 30 to be swapped out for another allows users to quickly update a game controller 2 with their preferred settings. A user may share a game console and even a controller body with family or friends, and by merely swapping faceplates 30 out, controller settings can be easily updated. A user may also prefer to use a specific faceplate 30 for a specific game. A user may desire to have a different stick sensitivity for a shooting game compared to a more casual role-playing game. This adjustment can be easily accomplished by simply swapping faceplates. In some situations, the user may want the programmable buttons 26 (FIG. 1) to have different inputs for different games and would prefer to swap the faceplate 30 rather than update the programmable buttons 26 for every game.

Although in the illustrated embodiment, the communication device 32 corresponds to the faceplate, in other embodiments, the communication device 32 may correspond to any swappable portion of a video game controller. Similar means of swapability may be applied to other individual aspects of the video game controller 2 such as the analog sticks 12 (FIG. 1). A user may swap out shorter analog sticks 12 for longer sticks depending on the game and want the sensitivity to adjust merely by swapping the sticks. In such a case, a communication device 32 or equivalent may be attached to analog sticks such that the swapping of a first set of sticks to a second sticks is detectable.

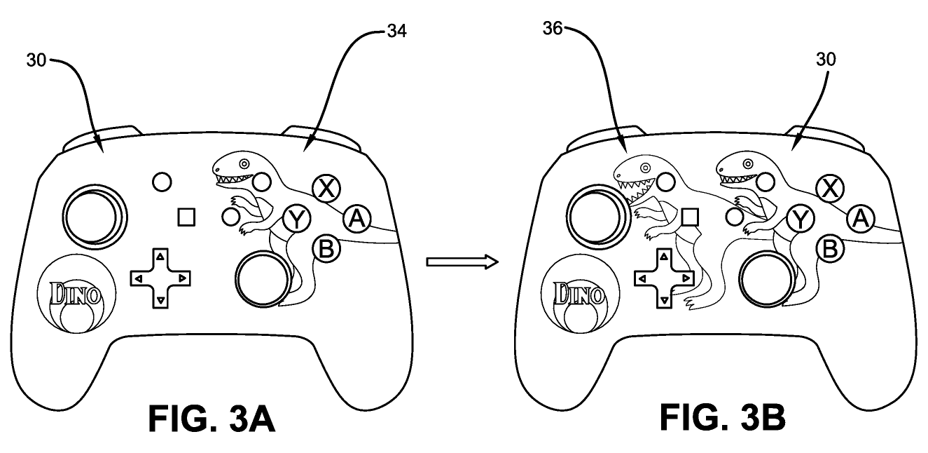

FIGS. 3A and 3B illustrate an example of a faceplate revealing hidden art. Artwork 34 can be added to the faceplate 30, for example, through a process called in-mold labeling. First, the artwork 34 is printed onto a label. The label may be paper or a similar material to the controller body 10. The label is then placed in a game controller mold, where it undergoes injection molding. The end result is the label containing the artwork 34 being fused together with the controller body 10. In some embodiments, areas of the controller body 10 may be etched away to create hidden art 36. The inside of the controller body 10 is dark enough that the etched away portion is not visible without additional lighting. However, light from the LEDs 22 can shine through the etched away portions, revealing the hidden art 36.

Each faceplate 30 containing hidden art 36 may have identifying data and/or other data that may be used to identify which LEDs 22 to illuminate to reveal the hidden art 36. In some embodiments, the LEDs 22 illuminating the hidden art 36 may be programmable, allowing a user to choose colors and/or effects. For example, a faceplate 30 containing hidden art 36 of thunderbolts or simple geometric shapes may wish to have certain areas of the hidden art 36 be illuminated red and some illuminated blue. In addition, the user can choose to have the LEDs 22 illuminate the hidden art 36 with effects, such as a breathing effect, where the light slowly fades in and out, a pulsing effect where the light flashes on and off, or a spiraling effect where the LEDs 22 light up in a circular pattern around the controller. As more LEDs 22 are added to the controller, it would be possible to increase the resolution of images displayed through the etched away portions 36 of controller body 10. With enough LEDs 22, the resolution may be high enough to display animated images, such as a character reacting to specific button presses. With a high enough resolution, the controller may be able to operate as a screen for the game being played.

Additionally, the rumble motors 24 can send signals to the processor 40 (FIG. 4) to illuminate the LEDs 22 based on activity of the rumble motors 24 or otherwise the LEDs 22 may be controlled based on activity of the rumble motors 24. For example, the rumble motors 24 may provide nuanced feedback, replicating everything from distant footsteps to cataclysmic earthquakes, with the LEDs 22 acting in concert with the physical feedback to provide additional visual feedback. The LEDs 22 may also be illuminated based on the audio of the game being played. As some users may not enjoy physical feedback, the LEDs may respond to the sounds in game, such as the footsteps or earthquakes mentioned previously. This allows a user to combine the gameplay into an audio and visual experience.

FIG. 4 illustrates a block diagram of an example customizable handheld game controller 2. The controller 2 includes a processor 40, a memory 42, a plurality of LEDs 22, a communication device 20, and a storage 44 operably connected by a bus 46.

In one example, the video game controller 2 may communicate with a gaming device via I/O Ports 48. In one example, the video game controller 2 may receive user input via the analog stick 12, trigger buttons 14, action buttons 16, directional pad 18, etc. and transmit user input signals to the gaming device via the I/O Ports 48. The processor 40 may communicate with the communication device 20, allowing faceplate communication device 32 to communicate data to the controller 40. In some embodiments, the processor 40 can program the plurality of LEDs 22 to light up in different configurations. Some configurations may include a pulsing effect, a swirling effect, or a breathing effect. In one example, the processor may instruct specific LEDs from the plurality of LEDs 22 to light up to illuminate hidden artwork etched into the faceplate.

The processor 40 can be a variety of various processors including dual microprocessor and other multi-processor architectures. The memory 42 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The storage 44 may be operably connected to the processor 40 via the bus 46. The storage 44 can include, but is not limited to, devices like a magnetic disk drive, a solid-state disk drive, a flash memory card, or a memory stick. The memory 42 can store processes or data. The storage 44 or memory 42 can store an operating system that controls and allocates resources of the video game controller 2.

The bus 46 can be a single internal bus interconnect architecture or other bus or mesh architectures. While a single bus is illustrated, it is to be appreciated that handheld game controller 2 may communicate with various devices, logics, and peripherals using other buses that are not illustrated (e.g., PCIE, SATA, Infiniband, 1394, USB, Ethernet). The bus 46 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The video game controller 2 may interact with input/output devices via I/O Ports 48. Input/output devices can include, but are not limited to, a keyboard, a microphone, a pointing and selection device, cameras, video cards, displays, gaming devices, and the like. The I/O Ports 48 can include but are not limited to, serial ports, parallel ports, and USB ports. The handheld game controller 2 can operate in a network environment and thus may be connected to network devices via the I/O Ports 48. Through the I/O Ports 48, the handheld game controller 2 may interact with a network. Through the network, the handheld game controller 2 may be logically connected to remote devices. The networks with which the handheld game controller 2 may interact include, but are not limited to, a local area network (LAN), a wide area network (WAN), and other networks. The I/O Ports 48 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the I/O Ports 48 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

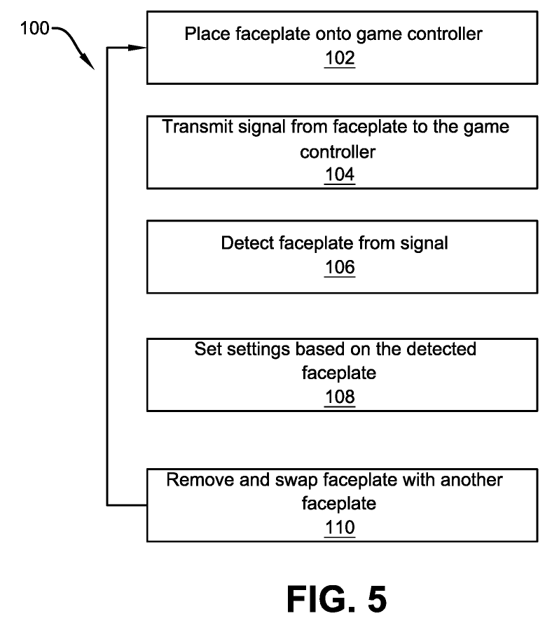

Example methods may be better appreciated with reference to the flow diagram of FIG. 5. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 5 illustrates a flow diagram for a method of adjusting controller settings of a controller by detecting a faceplate. The method 100 begins with step 102, where a user places a faceplate (e.g., containing hidden artwork) onto a game controller. In step 104, the communication devices of the faceplate and the video game controller interact, and the faceplate communication device transmits a data (e.g., signal identifying the faceplate, signal identifying which LEDs to illuminate to reveal the hidden art, etc.). In step 106, the processor on the video game controller processes the signal from the faceplate communication device and detects the faceplate. In step 108, the processor changes settings based on the received data (e.g., illuminates the corresponding LEDs) for the detected faceplate. If the settings correspond to LED lighting, for example, the hidden artwork may be revealed as the LEDs light up the etched away areas of the faceplate. In Step 110, the user may decide to remove the current faceplate and swap the faceplate out with another, whereby starting the process back at step 102.

Advantages of the detectable controller faceplate include, but are not limited to, a user being able to quickly change controller settings data on the fly and displaying hidden artwork on the faceplate based on the specific faceplate used. Quickly changing controller settings can be applicable to multiple situations such as changing faceplates and settings for specific games or changing faceplates and settings for specific users.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A video game controller comprising:
a controller body;
a controller communication device;
a plurality of light emitting diodes (LEDs) disposed in the controller body;
one or more processors disposed in the body and operatively connected the controller communication device and the plurality of LEDs; and
a faceplate configured to be connected to the body, wherein the faceplate further comprises a faceplate communication device configured to communicate with the controller communication device;
wherein the one or more processors are configured to control lighting of the plurality of LEDs based on detection of the faceplate being connected to the controller body by the controller communication device communicating with the faceplate communication device.

2. The video game controller of claim 1, wherein the faceplate further comprises:
artwork on the faceplate, wherein one or more areas of the artwork are translucent, such that light from the plurality of LEDs shines through the one or more areas.

3. The video game controller of claim 1, wherein the faceplate is configured to be removably connected to the controller body such that the faceplate is swappable with a second faceplate.

4. The video game controller of claim 1, further comprising at least one analog stick, at least two trigger buttons, at least one action button, and at least one directional pad operatively installed to the body of the video game controller;
wherein the one or more processors are operatively connected to the at least one analog stick, the at least two trigger buttons, the at least one action button, and the at least one directional pad to receive user input via the at least one analog stick, the at least two trigger buttons, the at least one action button, and the at least one directional pad.

5. The video game controller of claim 1, wherein the one or more processors control the plurality of LEDs based on sound received from a game system console.

6. The video game controller of claim 1, wherein the video game controller further includes one or more rumble motors, wherein the one or more processors control the plurality of LEDs based on feedback corresponding to the one or more rumble motors.

7. A method for adjusting one or more controller settings of a video game controller by detecting a faceplate comprising:
receiving a faceplate containing a faceplate communication device onto the video game controller;
receiving a signal from the faceplate communication device of the faceplate by a controller communication device connected to the video game controller as an indication of the receiving of the faceplate onto the video game controller; and
adjusting the one or more controller settings based on the indication of the receiving of the faceplate onto the video game controller.

8. The method for adjusting one or more controller settings of claim 7, further comprising:
illuminating LEDs based on the indication of the receiving of the faceplate onto the video game controller.

9. The method for adjusting one or more controller settings of claim 7, comprising:
illuminating LEDs based on the indication of the receiving of the faceplate onto the video game controller corresponding to a first faceplate differently from illuminating LEDs based on the indication of the receiving of the faceplate onto the video game controller corresponding to a second faceplate different from the first faceplate.

10. The method for adjusting one or more controller settings of claim 7, further comprising:
revealing hidden artwork on the faceplate by lighting LED behind the artwork in response to the indication of the receiving of the faceplate onto the video game controller.

11. A video game controller comprising:
a controller body;
a controller communication device configured to receive faceplate information;
at least one analog stick, at least two trigger buttons, at least one action button, and at least one directional pad operatively installed to the controller body; and
one or more processors disposed in the controller body, operatively connected the controller communication device, and configured to receive the faceplate information from the controller communication device;
wherein,
where the faceplate information corresponds to a first faceplate, the one or more processors are configured to set one or more controller settings to a first set of settings, and
where the faceplate information corresponds to a second faceplate different from the first faceplate, the one or more processors are configured to set the one or more controller settings to a second set of settings different from the first set of settings; and
wherein the one or more processors are operatively connected to the at least one analog stick, the at least two trigger buttons, the at least one action button, and the at least one directional pad to receive user input via the at least one analog stick, the at least two trigger buttons, the at least one action button, and the at least one directional pad.

12. The video game controller of claim 11, wherein one or more of the controller settings correspond to light settings for lighting up a plurality of LEDs on the video game controller.

13. The video game controller of claim 11, wherein the one or more processors control the plurality of LEDs based on sounds received from a video game console.

14. The video game controller of claim 11, wherein one or more of the controller settings correspond to light settings for lighting up a plurality of LEDs on the video game controller, such that the plurality of LEDs are set to a first lighting pattern when the first faceplate is installed to the video game controller and to a second lighting pattern different from the first lighting pattern when the second faceplate is installed to the video game controller.

15. The video game controller of claim 11, wherein the video game controller further includes one or more rumble motors and the one or more processors control the plurality of LEDs based on feedback from the one or more rumble motors.

16. The video game controller of claim 11, wherein one or more of the controller settings correspond to one or more programmable buttons on the video game controller such that the one or more programmable buttons are programmed to a first set of functions when the first faceplate is installed to the video game controller and to a second set of functions different from the first set of functions when the second faceplate is installed to the video game controller.

17. The video game controller of claim 11, wherein one or more of the controller settings is for assigning a stick sensitivity value to one or more control sticks.

18. A faceplate for a video game controller comprising:
a body; and
a communication device connected to the body and configured to interface with the video game controller;
wherein the communication device is configured to communicate controller setting data or faceplate identification information to the video game controller when in proximity to the video game controller.

19. The faceplate of claim 18, wherein the communication device uses near field communication (NFC), radio frequency identification (RFID), Bluetooth low energy (BLE), or magnetic secure transmission (MST).

20. The faceplate of claim 18, further comprising:
outer portions having artwork thereon, the artwork or outer portions being translucent and configured to allow light from LEDs of the video game controller to shine through.
